(19) United States
(12) Patent Application Publication
(10) Pub. No.: US 2008/0062874 A1
(43) Pub. Date: Mar. 13, 2008

(54) NETWORK MONITORING DEVICE AND NETWORK MONITORING METHOD

(75) Inventor: Toru Shimadoi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/742,517

(22) Filed: Apr. 30, 2007

(30) Foreign Application Priority Data
Sep. 11, 2006 (JP) 2006-245805

(51) Int. Cl. H04L 12/26

(52) U.S. Cl. 370/232

(57) ABSTRACT

A transmitting unit includes a plurality of ports, and transmits a monitor packet from a port corresponding to a target network to be monitored. An extracting unit extracts transmitted monitor packet from received packets. A judging unit judges whether a loop is formed in a network that is configure by connecting a plurality of communication devices, based on a transmission-source address of extracted monitor packet. A blocking unit blocks, when it is judged that the loop is formed in the network, the port from which the monitor packet has been transmitted.

### BACKGROUND OF THE INVENTION

1. Field of the Invention

The present invention relates to a technology for monitoring a network configured by connecting a plurality of communication devices.

2. Description of the Related Art

Conventionally, technologies, such as synchronous digital hierarchy (SDH) and asynchronous transfer mode (ATM), are primarily used in a core network having a broad bandwidth and high reliability (for example, virtual private networks (VPN) and content distribution networks [CDN] constructed by an internet service provider (ISP)).

However, with technological innovation, various local area network (LAN) devices are being provided at a low cost. Therefore, a large majority of end users, including large-scale corporate users, use LAN using Ethernet (registered trademark) and internet protocol (IP). Introduction of the Ethernet (registered trademark) and the IP to access networks and core networks is advancing.

In recent years, numerous devices are connected within such networks, making the networks flexible and complex. For example, a single Ethernet (registered trademark) network is divided into a plurality of virtual LAN (VLAN). However, as topologies of the networks become complex, it becomes essential to confirm that a packet transmitted by a user has definitely reached a transmission destination.

Therefore, for example, as described in Japanese Patent Application Laid-open No. H11-32000, a network continuity test may be performed. In the network continuity test, a telegraphic message used for testing is transmitted to a particular destination. Whether the particular destination successfully receives the telegraphic message is confirmed.

However, even when the network continuity test is performed, if the packet does not reach the correct destination, it is difficult to judge whether the packet not reaching the correct destination is a temporary situation caused by a malfunctioning device, etc., or a permanent situation caused by a formation of a loop within the network configuration, etc. When the loop is formed within the network configuration, changes are required to be made in the network configuration to eliminate the loop. Relatively large-scale modifications are required. Many network resources will most likely not function correctly during a modification. Therefore, it is preferable that loops within a network, in particular, are quickly found and handled.

Furthermore, when an area in which the loop is formed is identified and the identified area is larger than the actual loop, loop elimination becomes inefficient if, for example, communication in the entire area is terminated to take measures to eliminate the loop.

### SUMMARY OF THE INVENTION

It is an object of the present invention to at least partially solve the problems in the conventional technology.

A network monitoring device according to one aspect of the present invention monitors a network configured by connecting a plurality of communication devices. The network monitoring device includes a transmitting unit that includes a plurality of ports, and transmits a monitor packet from a port corresponding to a target network to be monitored; an extracting unit that extracts transmitted monitor packet from received packets; a judging unit that judges whether a loop is formed in the network, based on a transmission-source address of extracted monitor packet; and a blocking unit that blocks, when it is judged that the loop is formed in the network, the port from which the monitor packet has been transmitted.

A method of monitoring a network configured by connecting a plurality of communication devices, according to another aspect of the present invention, includes transmitting a monitor packet from a port of a communication device having a plurality of ports, the port corresponding to a target network to be monitored; extracting transmitted monitor packet from packets received by the communication device; judging whether a loop is formed in the network, based on a transmission-source address of extracted monitor packet; and blocking, when it is judged that the loop is formed in the network, the port from which the monitor packet has been transmitted.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a communication network according to a first embodiment of the present invention;

FIG. 2 is a block diagram of a main configuration of a switch device according to the first embodiment;

FIG. 3A is a diagram of a format example of a monitor packet according to the first embodiment;

FIG. 3B is a diagram of another format example of the monitor packet according to the first embodiment;

FIG. 4 is a flowchart of a loop detection operation according to the first embodiment;

FIG. 5 is a block diagram of a main configuration of a switch device according to a second embodiment of the present invention; and

FIG. 6 is a flowchart of a loop detection operation according to the second embodiment.

### DETAILED DESCRIPTION OF THE PREFERRED EMBODIMENTS

Exemplary embodiments of the present invention are described in detail below with reference to the accompanying drawings.

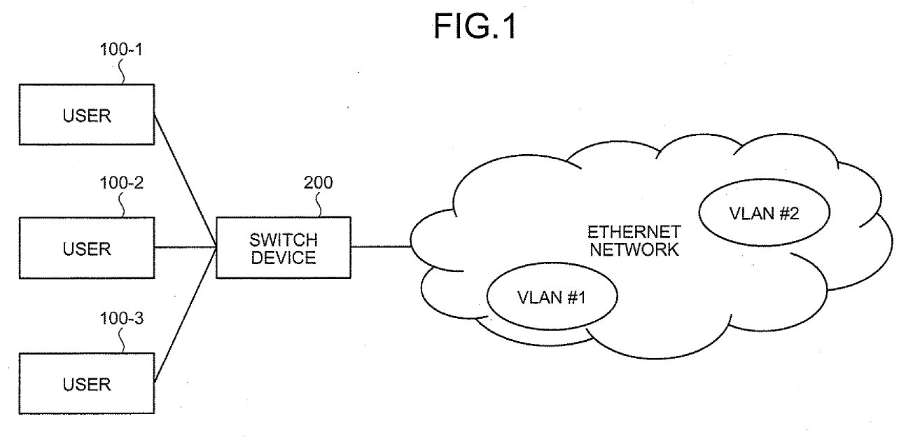

FIG. 1 is a schematic of a communication network according to a first embodiment of the present invention. According to the first embodiment, a plurality of users 100-1 to 100-3 are connected to an Ethernet (registered trademark) network, via a switch device 200. A plurality of VLANs (two VLAN, VLAN #1 and VLAN #2, are shown in the figure) are included in the Ethernet (registered trademark) network.

Each of the VLANs and the Ethernet (registered trademark) network respectively include a router, a plurality of switch devices, such as an L2 switch, a plurality of users, and the like. A loop may be formed in a section of the VLAN or the Ethernet (registered trademark) network because a large number of switch devices are connected within the VLAN and the Ethernet (registered trademark) network.

The users 100-1 to 100-3 are terminal devices respectively provided at the terminals of each VLAN and the Ethernet (registered trademark) network. The users 100-1 to 100-3 transmit and receive packets to and from other terminal devices and the like within each VLAN and the Ethernet (registered trademark) network, via the switch device 200.

The switch device 200 receives a packet from the user 100-1 to 100-3 or each VLAN and the Ethernet (registered trademark) network. The switch device 200 outputs the packet from a transmission port corresponding with a transmission-destination address of the packet. In other words, the switch device 200 relays the packet so that the packet reaches the transmission-destination address.

In addition, the switch device 200 periodically transmits a monitor packet to each VLAN and the Ethernet (registered trademark) network. The transmission-destination address of the monitor packet is an address of a local address or, in other words, an address of the switch device 200, The switch device 200 monitors whether the monitor packet is received by the switch device 200, thereby detecting the loop within each VAL and the Ethernet (registered trademark) network. When the loop is detected, the switch device 200 blocks the transmission port from which the monitor packet used for loop detection has been transmitted.

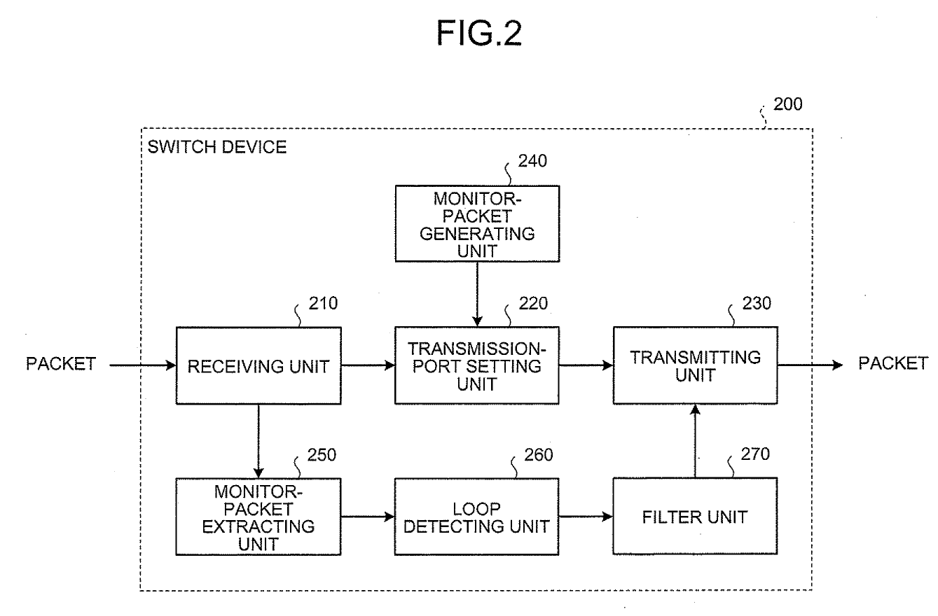

FIG. 2 is a block diagram of a main configuration of the switch device 200 according to the first embodiment. The switch device 200 includes a receiving unit 210, a transmission-port setting unit 220, a transmitting unit 230, a monitor-packet generating unit 240, a monitor-packet extracting unit 250, a loop detecting unit 260, and a filter unit 270.

The receiving unit 210 receives the packet from the users 100-1 to 100-3 or each VLAN and the Ethernet (registered trademark) network. When the received packet is an ordinary data packet, the receiving unit 210 outputs the packet to the transmission-port setting unit 220.

The transmission-port setting unit 220 refers to a header on the data packet outputted from the receiving unit 210 and a header on a monitor packet outputted from the monitor-packet generating unit 240, and confirms the transmission-destination addresses. Then, the transmission-port setting unit 220 sets the transmission ports to the ports corresponding with the transmission-destination addresses of the data packet and the monitor packet. The transmission-port setting unit 220 sets the transmission ports of the data packet and the monitor packet by, for example, referring to a table storing correspondence between the addresses and the ports. The port receives the packet of which the transmission-destination address is the corresponding address.

The transmitting unit 230 includes a plurality of physical ports. The transmitting unit 230 outputs the data packet and the monitor packet from the transmission ports set by the transmission-port setting unit 220 and transmits the data packet and the monitor packet. Each physical port in the transmitting unit 230 includes a plurality of virtual logical ports. The logical ports correspond to each VLAN.

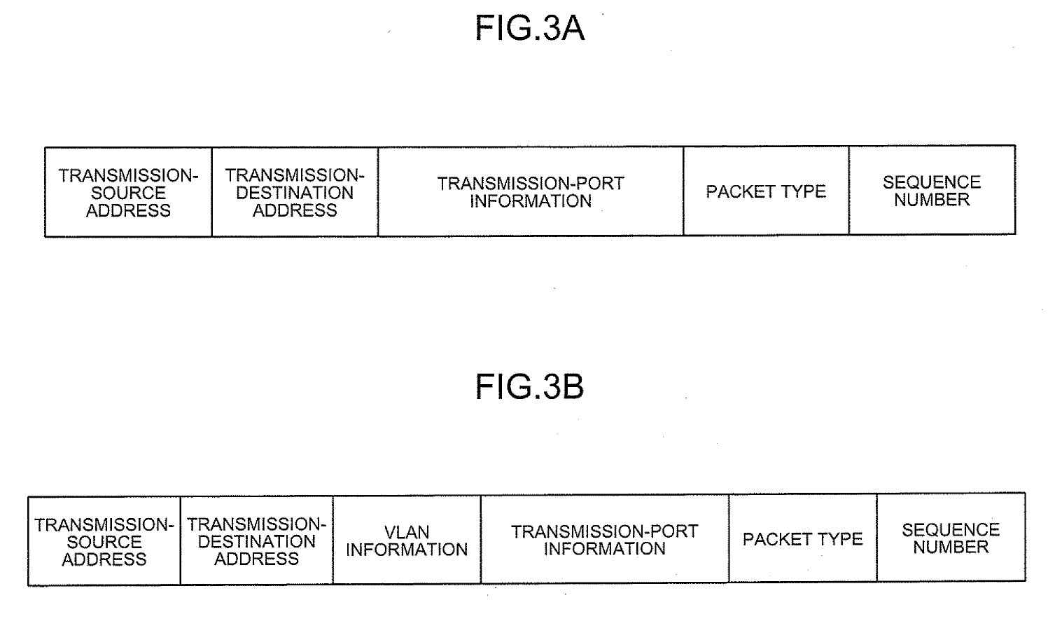

The monitor-packet generating unit 240 generates the monitor packet at every predetermined period and outputs the monitor packet to the transmission-port setting unit 220. The transmission-destination address of the monitor packet is the address of the local address. Specifically, the monitor-packet generating unit 240 generates the monitor packet in a format such as that shown in FIG. 3A and FIG. 3B.

FIG. 3A shows a format example of the monitor packet used for detecting loops by physical port units. The physical ports are in the transmitting unit 230. In the example, a transmission-source address field stores the address of the local address. A transmission-destination address field stores an arbitrary address. A transmission-port information field stores information identifying the transmission port from which the monitor packet is transmitted. The information includes a slot number of the transmission port, a port type, a physical port number, a logical port number, and the like. The port type refers to whether the transmission port is the physical port or the logical port. However, in FIG. 3A, the monitor packet is used to detect the loop by physical port units. Therefore, the logical port number is invalid. A packet type field stores information stating that the packet is the monitor packet that has been used for the loop detection. A sequence number field stores a serial number of the monitor packet. The slot is a unit by which a plurality of physical ports are housed. For example, the switch device 200 includes four slots. Each slot houses 32 physical ports. In other words, the slot number is a number attached to the slot housing the transmission port.

At the same time, FIG. 3B shows a format example of a monitor packet for detecting the loop by logical port units. The logical ports form the physical ports in the transmitting unit 230. In other words, the loop can be detected by VLAN units using the monitor packet shown in FIG. 3B. In this example, a VLAN information field is added to the format shown in FIG. 3A. The VLAN information field stores identification information used to identify the VLAN. The monitor-packet generating unit 240 stores the identification information of each VLAN in a predetermined order every time the monitor packet is generated, so that all VLAN within the Ethernet (registered trademark) network are equally identified by the identification information stored in the LAN information field. The transmission-port information field stores the logical port numbers corresponding to respective VLAN.

The monitor-packet extracting unit 250 extracts the monitor packet from among the packets received by the receiving unit 210. Specifically, the monitor-packet extracting unit 250 refers to the packet type field of the packet received by the receiving unit 210 and extracts the monitor packet. The monitor packet stores information stating that the monitor packet is used for loop detection.

The loop detecting unit 260 refers to the transmission-source address field of the monitor packet extracted by the monitor-packet extracting unit 250 and detects the monitor packet having the transmission-source address field to which the address of the local address is stored. As a result, the loop is detected from within each VLAN or the Ethernet (registered trademark) network.

When the loop detecting unit 260 detects the loop, a filter unit 207 refers to the transmission-port information of the monitor packet used for the loop detection. The filter unit 207 filters the physical port or the logical port in the transmitting unit 230 in which the loop occurs and blocks the port.

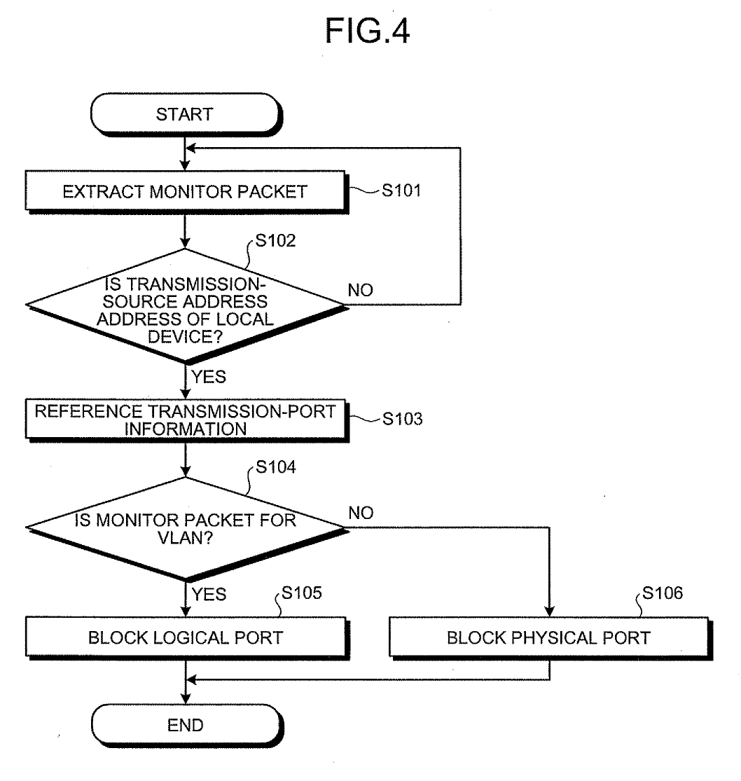

A loop detection operation performed by the switch device 200, configured as above, will be explained with reference to the flowchart shown in FIG. 4. Here, the monitor packet generated by the monitor-packet generating unit 240 is already being transmitted to each VLAN and the Ethernet (registered trademark) network.

The receiving unit 210 continuously receives data packets transmitted from the users 100-1 to 100-3, data packets of which the transmission destinations are the users 100-1 to 100-3, and monitor packets transmitted from other switch devices. When a loop including the switch device 200 is formed in each VLAN or the Ethernet (registered trademark) network, the receiving unit 210 receives the monitor packet transmitted from the switch device 200.

Then, the monitor-packet extracting unit 250 extracts the monitor packet from among the packets received by the receiving unit 210 (Step S101). In other words, the monitor-packet extracting unit 250 refers to the packet type fields of the packets received by the receiving unit 210 and extracts the monitor packet to which information stating that the monitor packet is used for the loop detection is stored. The monitor packets transmitted from the other switch devices are also included within the extracted monitor packets.

Then, the loop detecting unit 260 refers to the transmission-source address field of the monitor packet extracted by the monitor-packet extracting unit 250 and judges whether the address of the local address is stored (Step S102). When the address stored in the transmission-source address field is judged not to be the address of the local address as a result of the judgment (Step S102; No), the monitor packet extracted by the monitor-packet extracting unit 250 is judged to be the monitor packet transmitted from another switch device. Since the loop is not necessarily formed in this case, the monitor-packet extracting unit 250 continues extracting the monitor packets.

At the same time, when the address of the local address is judged to be stored in the transmission-source address field (Step S102; Yes), the monitor packet transmitted from the switch device 200 is once again received by the switch device 200. Therefore, it can be considered that the loop is formed. As a result, the filter unit 270 refers to the transmission-port information field of the monitor packet (Step S103) and confirms the physical port number of the physical port and the logical port number of the logical port from which the monitor packet is transmitted.

The filter unit 270 judges whether the monitor packet is for the VLAN based on the port type in the transmission-port information field (Step S104). In other words, the filter unit 270 judges whether the port type in the transmission-port information field is the physical port or the logical port. When the port type is the physical port or, in other words, the monitor packet is not for the VLAN (Step S104; No), the physical port having the physical port number stored in the transmission-port information field is blocked (Step S106). When the port type is the logical port or, in other words, the monitor packet is for the VLAN (Step S104; Yes), the logical port having the logical port number stored in the transmission-port information field is blocked (Step S105).

When the monitor packet is for the VLAN, only the logical port corresponding with the VLAN in which the loop is formed is blocked. The other logical ports forming the physical port to which the blocked logical port belongs are not blocked. Therefore, the VLAN in which the loop is not formed remains able to communicate even during packet communication using the same physical port. As a result, decrease in throughput of the overall Ethernet (registered trademark) network caused by the blocking process can be kept at a minimum. The loop formed within the network configuration can be eliminated through appropriate measures being taken while the transmission port is blocked by VLAN units. The appropriate measures include, for example, a topology of the network being changed.

As described above, according to the first embodiment, when switch device periodically transmits the monitor packet by VLAN units and receives the monitor packet transmitted by the same switch device, the switch device blocks the transmission port used to transmit the monitor packet. The transmission port is blocked by VLAN. Therefore, when the loop is formed within the network, the packet communication can be terminated by unit of VLAN in which the loop is present, without performing unnecessary blocking processes. The switch device can detect the loop formed in the network configuration and efficiently eliminate the loop.

According to a second embodiment of the present invention, the switch device stores the transmission-source addresses of the monitor packets transmitted from the other switch devices and uses the monitor packets from the other switch devices, in addition to the monitor packet from the same switch device. Therefore, the switch device detects the loop more quickly.

The configuration of the communication network according to the second embodiment is the same as that according to the first embodiment (see FIG. 1) Explanations thereof are omitted. According to the second embodiment, the configuration of the switch device 200 differs from that according to the first embodiment.

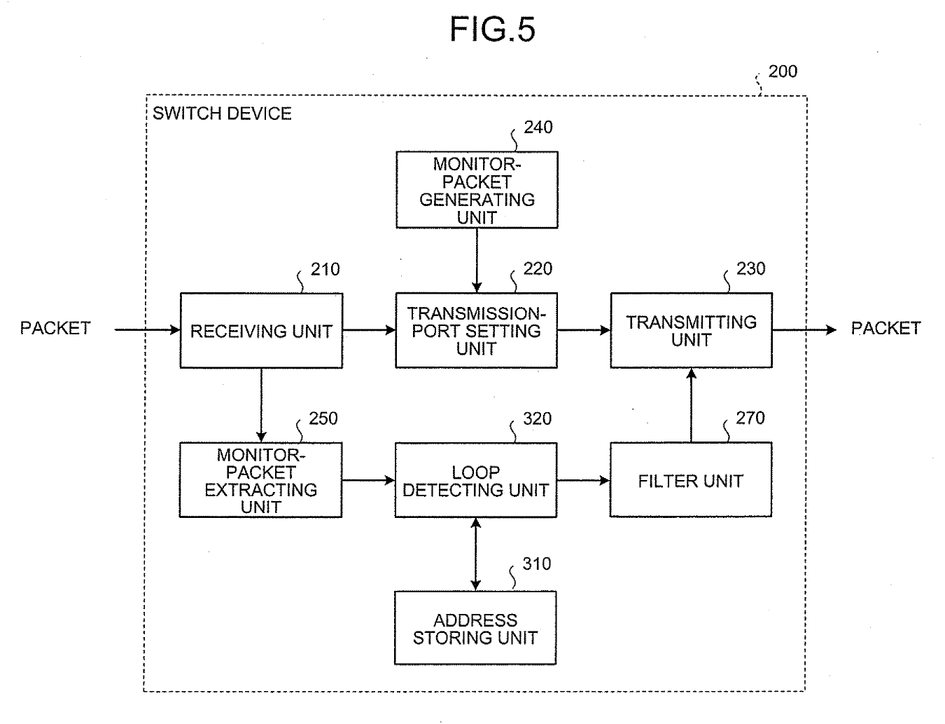

FIG. 5 is a block diagram of a main configuration of the switch device 200 according to the second embodiment. Components within the diagram that are the same as those in FIG. 2 are given the same reference numbers. Explanations thereof are omitted. The switch device 200 shown in FIG. 5 includes an address storing unit 310 added to the switch device 200 shown in FIG. 2. A loop detecting unit 320 replaces the loop detecting unit 260.

The address storing unit 310 stores an address of which notification is given by the loop detecting unit 320. Specifically, the address storing unit 310 stores the identification information (for example, a combination of the transmission-source address and the sequence number, or the like) that can be used to identify the monitor packet. The identification information includes the transmission-source addresses of the monitor packets transmitted from the other switch devices, among the monitor packets extracted by the monitor-packet extracting unit 250. When the loop detecting unit 320 detects the loop, the address storing unit 310 deletes the identification information of the monitor packet used for the loop detection. The address storing unit 310 can delete the identification information that has been stored for more than a predetermined amount of time.

The loop detecting unit 320 refers to the transmission-source address field of the monitor packet extracted by the monitor-packet extracting unit 250 and detects the monitor packet having the transmission-source address field to which the address of the local address is stored. As a result, the loop detecting unit 320 detects the loop within each VLAN or the Ethernet (registered trademark) network. The loop detecting unit 320 compares the monitor packet extracted by the monitor-packet extracting unit 250 and the identification information stored in the address storing unit 310. When the identification information matching the monitor packet is determined to be stored in the address storing unit 310 and the same monitor packet is determined to be received twice, the loop detecting unit 320 judges that the loop is detected. A notification of the loop detection is sent to the filter unit 270 and the address storing unit 310. Furthermore, if the transmission-source address of the monitor packet extracted by the monitor-packet extracting unit 250 is not stored in the address storing unit 310, the loop detecting unit 320 stores the identification information including the transmission-source address in the address storing unit 310.

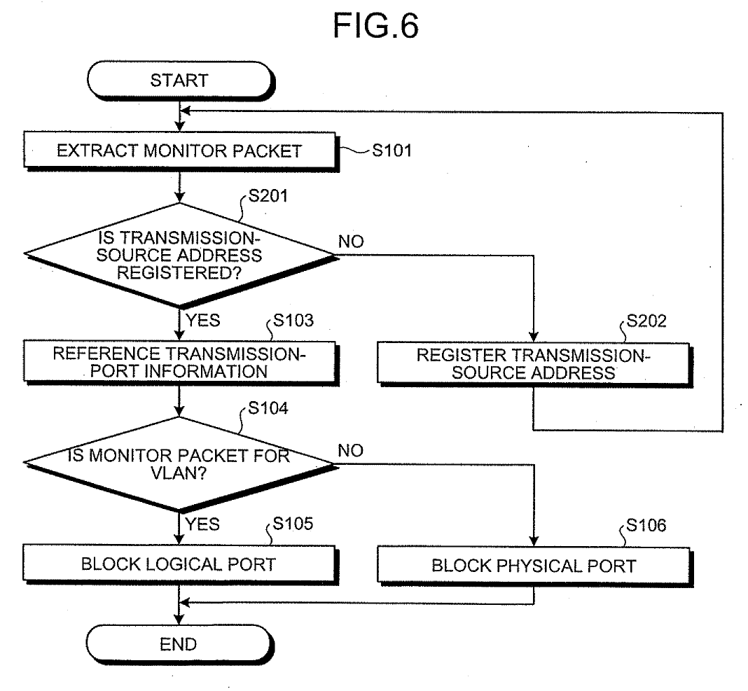

Next, a loop detection operation according to the switch device 200, configured as described above, will be explained with reference to a flowchart shown in FIG. 6. Steps in the flowchart shown in FIG. 6 that are the same as those in FIG. 4 are given the same reference numbers. Detailed explanations thereof are omitted. The monitor packet generated by the monitor-packet generating unit 240 and the monitor packets generated by the other switch devices are transmitted to each VLAN and the Ethernet (registered trademark) network in advance.

When the receiving unit 210 receives the packet, the monitor-packet extracting unit 250 extracts the monitor packet (Step S101). The monitor packets transmitted from the other switch devices are also included within the monitor packets extracted by the monitor-packet extracting unit 250.

Then, the loop detecting unit 320 refers to the transmission-source address field of the monitor packet extracted by the monitor-packet extracting unit 250 and judges whether the address of the local address is stored. In addition the loop detecting unit 320 judges whether the transmission-source address is already stored in the address storing unit 310 (Step S201). When the transmission-source address is judged not to be the address of the switch device 200 and is judged not to be registered in the address storing unit 310 (Step S201; No) as a result of the judgment, the monitor packet extracted by the monitor-packet extracting unit 250 is judged to be a first monitor packet received from another switch device. The identification information, including the transmission-source address, is registered in the address storing unit 310 to use the transmission-source address of the monitor packet for loop detection (Step S202). Then, the monitor-packet extracting unit 250 continues extracting the monitor packets.

At the same time, when the transmission-source address is judged to be the address of the switch device 200 or is judged to be stored in the address storing unit 310 (Step S201; Yes), and a monitor packet that is the same as a monitor packet that has once been transmitted from the switch device 200 is once again received by the switch device 200, the loop is considered to be formed. Therefore, the filter unit 270 refers to the transmission-port information field of the monitor packet (Step S103) and confirms the physical port number and the logical port number of the physical port and the logical port from which the monitor packet is transmitted.

If the identification information used for the loop detection remains registered in the address storing unit 310, the loop is detected again when the monitor packet is transmitted from the transmission-source address registered in the address storing unit 310, after the loop has been eliminated. Therefore, the loop detecting unit 320 deletes the identification information registered in the address storing unit 310 that matches the monitor packet currently extracted by the monitor-packet extracting unit 250. Thus, the identification information of the monitor packet used for the loop detection is deleted every time the loop detecting unit 320 detects a loop. Furthermore, the identification information registered in the address storing unit 310 can be deleted after an elapse of a certain amount of time. In other words, when a period from a first reception of a monitor packet to a second reception of the monitor packet is too long, reliability of the loop detection deteriorates. Therefore, old identification information is deleted to prevent the deterioration in reliability.

According to the second embodiment, the switch device 200 detects the loop in the network using not only the monitor packets generated by the monitor-packet generating unit 240 in the switch device 200, but also the monitor packets transmitted from the other switch devices. Therefore, the monitor packets are sent more frequently than in a cycle in which the monitor packets are generated by the monitor-packet generating unit 240 of the switch device 200. Thus, the switch device 200 can efficiently perform the loop detection. In particular, when numerous VLAN are included within the Ethernet (registered trademark) network, the loop detection can be efficiently performed within each VLAN.

Returning to the explanation of FIG. 6, the filter unit 270 confirms the physical port number and the logical port number. At the same time, the filter unit 270 judges whether the monitor packet is for VLAN from the port type in the transmission-source address field (Step S104). When the monitor packet is judged not to be for VLAN (Step S104; No) as a result of the judgment, the physical port having the physical port number stored in the transmission-port information field is blocked (Step S106). When the monitor packet is judged to be for VLAN (Step 3104; Yes) the logical port having the logical port number stored in the transmission-port information field is blocked (Step S105).

As described above, according to the second embodiment, the switch device 200 stores the transmission-source addresses of the monitor packets transmitted from the other switch devices. When the switch device 200 once again receives the monitor packet transmitted from the switch device 200, in addition to the monitor packet generated by the switch device 200, the switch device 200 judges that the loop is formed. Therefore, the loop can be detected more quickly and efficiently than when only the monitor packet generated by the switch device 200 is used.

According to an embodiment of the present invention, a network monitoring device transmits a monitor packet from a port corresponding to a network to be monitored. The port is included in a communication device having a plurality of ports. The network monitoring device extracts the monitor packet from among packets received by the communication device. The network monitoring device judges whether a loop is formed, based on a transmission-source address of the extracted monitor packet. When the loop is judged to be formed as a result of the judgment, the network monitoring device blocks the port of the communication device from which the monitor packet has been transmitted. The network monitoring device detects a reception of a monitor packet that is the same as the transmitted monitor packet and detects the loop formed in the network configuration. Simultaneously, the network monitoring device terminates a packet transmission to the port corresponding with the network in which the loop is formed, allowing changes to be made in the network configuration. As a result, the loop can be efficiently eliminated.

Furthermore, according to an embodiment of the present invention, the network monitoring device judges that the loop is formed when a monitor packet of which the transmission-source address is an address of the local address is extracted. The network monitoring device detects that the monitor packet transmitted from the network monitoring device is once again received by the network monitoring device. As a result, the loop is detected with certainty.

Moreover, according to an embodiment of the present invention, the network monitoring device stores identification information identifying the extracted monitor packets. When a monitor packet that is the same as a monitor packet of which the identification information is stored is once again extracted, the network monitoring device judges that the loop is formed. Therefore, the network monitoring device can detect the loop using the monitor packets transmitted from other network monitoring devices. As a result, the loop detection can be efficiently performed.

Furthermore, according to an embodiment of the present invention, the network monitoring device stores identification information including the transmission-source addresses of the monitor packets. Therefore, the network monitor device can easily identify each monitor packet by the transmission source generating the monitor packet.

Moreover, according to an embodiment of the present invention, the network monitoring device deletes the identification information used for judgment when the loop judged to be formed. Therefore, erroneous loop detection caused by the identification information remaining stored even after the loop is eliminated can be prevented.

Furthermore, according to an embodiment of the present invention, the network monitoring device deletes identification information that has been stored for more than a predetermined amount of time. Therefore, when a long time elapses from when the monitor packet is first transmitted, the network monitoring device does not judge the loop to be formed even when the same monitor packet is received. As a result, deterioration in the reliability of the loop detection can be prevented.

Moreover, according to an embodiment of the present invention, the network monitoring device transmits the monitor packet from a logical port corresponding to a VLAN and performs blocking processes by VLAN units. Therefore, the network monitoring device does not block logical ports corresponding to the VLAN in which the loop is not detected. As a result, the loop is eliminated by performance of a minimum number of blocking processes.

Furthermore, according to an embodiment of the present invention, the network monitoring device generates the monitor packet storing the address of the network monitoring device as the transmission-source address and storing information on the port corresponding to the network to be monitored. Therefore, generation of the monitor packets to extraction of the monitor packets can be performed by one device. The loop can be detected through processes performed by only one device.

Moreover, according to an embodiment of the present invention, the network monitoring device successively transmits the monitor packets at a predetermined cycle from ports respectively corresponding to the networks. Therefore, for example, the network monitoring device can successively transmit different monitor packets for each network, such as VLAN, and equally monitor the networks.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A network monitoring device that monitors a network configured by connecting a plurality of communication devices, the network monitoring device comprising:
a transmitting unit that includes a plurality of ports, and transmits a monitor packet from a port corresponding to a target network to be monitored;
an extracting unit that extracts transmitted monitor packet from received packets;
a judging unit that judges whether a loop is formed in the network, based on a transmission-source address of extracted monitor packet; and
a blocking unit that blocks, when it is judged that the loop is formed in the network, the port from which the monitor packet has been transmitted.

2. The network monitoring device according to claim 1, wherein
the judging unit judges that the loop is formed in the network when the transmission-source address of the extracted monitor packet is an address of the network monitoring device.

3. The network monitoring device according to claim 1, further comprising:
a storing unit that stores identification information for identifying the extracted monitor packet, wherein
the judging unit judges that the loop is formed in the network when a same monitor packet as the monitor packet of which the identification information is stored is extracted again.

4. The network monitoring device according to claim 3, wherein
the identification information includes the transmission-source address of the extracted monitor packet.

5. The network monitoring device according to claim 3, wherein
when it is judged that the loop is formed in the network, the storing unit deletes identification information that is used for judgment.

6. The network monitoring device according to claim 3, wherein
the storing unit deletes identification information that has been stored for more than a predetermined time.

7. The network monitoring device according to claim 1, wherein
the transmitting unit transmits the monitor packet from a logical port corresponding to a virtual local area network, and
the blocking unit performs a blocking process in units of logical ports.

8. The network monitoring device according to claim 1, wherein
the transmitting unit includes a generating unit that generates a monitor packet that stores therein an address of the network monitoring device as the transmission-source address and information on the port corresponding to the target network.

9. The network monitoring device according to claim 1, wherein
the transmitting unit successively transmits monitor packets at a predetermined cycle from ports respectively corresponding to a plurality of networks.

10. A method of monitoring a network configured by connecting a plurality of communication devices, the method comprising:
transmitting a monitor packet from a port of a communication device having a plurality of ports, the port corresponding to a target network to be monitored;
extracting transmitted monitor packet from packets received by the communication device;
judging whether a loop is formed in the network, based on a transmission-source address of extracted monitor packet; and
blocking, when it is judged that the loop is formed in the network, the port from which the monitor packet has been transmitted.
